(19) United States
(12) Patent Application Publication
(10) Pub. No.: US 2016/0353146 A1
(43) Pub. Date: Dec. 1, 2016

(54) METHOD AND APPARATUS TO REDUCE SPHERICAL VIDEO BANDWIDTH TO USER HEADSET

(71) Applicant: GOOGLE INC., Mountain View, CA (US)

(72) Inventors: Joshua WEAVER, Mountain View, CA (US); Noam GEFEN, New York, NY (US); Husain BENGALI, Redmond, WA (US); Riley ADAMS, Mountain View, CA (US)

(21) Appl. No.: 15/167,206

(22) Filed: May 27, 2016

Related U.S. Application Data
(60) Provisional application No. 62/167,261, filed on May 27, 2015.

(51) Int. Cl. H04N 21/2662; H04N 13/00; H04N 21/239

(52) U.S. Cl. CPC H04N 21/2662; H04N 21/239; H04N 13/0014; H04N 13/0059; H04N 13/0055; H04N 13/0048

(57) ABSTRACT

A method includes determining at least one preferred view perspective associated with a three dimensional (3D) video, encoding a first portion of the 3D video corresponding to the at least one preferred view perspective at a first quality, and encoding a second portion of the 3D video at a second quality, the first quality being a higher quality as compared to the second quality.

### CROSS REFERENCE TO RELATED APPLICATION(S)

This application claims the benefit of U.S. Application Ser. No. 62/167,121, filed on May 27, 2015, titled “Method and Apparatus to Reduce Spherical Video Bandwidth to User Headset,” which is incorporated herein by reference in its entirety.

### FIELD

Embodiments relate to streaming spherical video.

### BACKGROUND

Streaming spherical video (or other three dimensional video) can consume a significant amount of system resources. For example, an encoded spherical video can include a large number of bits for transmission which can consume a significant amount of bandwidth as well as processing and memory associated with encoders and decoders.

### SUMMARY

Example embodiments describe systems and methods to optimize streaming video, streaming 3D video and/or streaming spherical video.

In a general aspect, a method includes determining at least one preferred view perspective associated with a three dimensional (3D) video, encoding a first portion of the 3D video corresponding to the at least one preferred view perspective at a first quality, and encoding a second portion of the 3D video at a second quality, the first quality being a higher quality as compared to the second quality.

In another general aspect, a server and/or streaming server includes a controller configured to determine at least one preferred view perspective associated with a three dimensional (3D) video, and an encoder configured to encode a first portion of the 3D video corresponding to the at least one preferred view perspective at a first quality, and encode a second portion of the 3D video at a second quality, the first quality being a higher quality as compared to the second quality.

In still another general aspect, a method includes receiving a request for a streaming video, the request including an indication of a user view perspective associated with a three dimensional (3D) video, determining whether the user view perspective is stored in a view perspective datastore, upon determining the user view perspective is stored in the view perspective datastore, increment a ranking value associated with the user view perspective, and upon determining the user view perspective is not stored in the view perspective datastore, add the user view perspective to the view perspective datastore and set the ranking value associated with the user view perspective to one (1).

Implementations can include one or more of the following features. For example, the method (or implementation on a server) can further include, storing the first portion of the 3D video in a datastore, storing the second portion of the 3D video in the datastore, receiving a request for a streaming video, and streaming the first portion of the 3D video and the second portion of the 3D video from the datastore as the streaming video. The method (or implementation on a server) can further include, receiving a request for a streaming video, the request including an indication of a user view perspective, selecting 3D video corresponding to the user view perspective as the encoded first portion of the 3D video, and streaming the selected first portion of the 3D video and the second portion of the 3D video as the streaming video.

The method (or implementation on a server) can further include, receiving a request for a streaming video, the request including an indication of a user view perspective associated with the 3D video, determining whether the user view perspective is stored in a view perspective datastore, upon determining the user view perspective is stored in the view perspective datastore, increment a counter associated with the user view perspective, and upon determining the user view perspective is not stored in the view perspective datastore, add the user view perspective to the view perspective datastore and set the counter associated with the user view perspective to one (1). The method (or implementation on a server) can further include, encoding the second portion of the 3D video includes using at least one first Quality of Service QoS parameter in a first pass encoding operation, and encoding the first portion of the 3D video includes using at least one second Quality of Service QoS parameter in a second pass encoding operation.

For example, the determining of the at least one preferred view perspective associated with the 3D video is based on at least one of a historically viewed point of reference and a historically viewed view perspective. The at least one preferred view perspective associated with the 3D video is based on at least one of an orientation of a viewer of the 3D video, a position of a viewer of the 3D video, point of a viewer of the 3D video and focal point of a viewer of the 3D video. The determining of the at least one preferred view perspective associated with the 3D video is based on a default view perspective, and the default view perspective based on at least one of a characteristic of a user of a display device, a characteristic of a group associated with the user of the display device, a directors cut, and a characteristic of the 3D video. For example, the method (or implementation on a server) can further include, iteratively encoding at least one portion of the second portion of the 3D video at the first quality, and streaming the least one portion of the second portion of the 3D video.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1A illustrates a two dimensional (2D) representation of a sphere according to at least one example embodiment.

FIG. 1B illustrates an unwrapped cylindrical representation of the 2D representation of a sphere as a 2D rectangular representation.

FIGS. 2-5 illustrate methods for encoding streaming spherical video according to at least one example embodiment.

FIG. 6A illustrates a video encoder system according to at least one example embodiment.

FIG. 6B illustrates a video decoder system according to at least one example embodiment.

FIG. 7A illustrates a flow diagram for a video encoder system according to at least one example embodiment.

FIG. 7B illustrates a flow diagram for a video decoder system according to at least one example embodiment.

FIG. 8 illustrates a system according to at least one example embodiment.

FIG. 9 is a schematic block diagram of a computer device and a mobile computer device that can be used to implement the techniques described herein.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting properties encompassed by example embodiments. For example, the positioning of structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Example embodiments describe systems and methods configured to optimize streaming of video, streaming of 3D video, streaming of spherical video (and/or other three dimensional video) based on preferentially (e.g., a directors cut, historical viewings, and the like) viewed (by a viewer of a video) portions of the spherical video. For example, a directors cut can be a view perspective as selected by the director or maker of a video. The directors cut may be based on the view of the camera (of a plurality of cameras) selected by or viewed as the director or maker of the video records the video.

A spherical video, a frame of a spherical video and/or spherical image can have perspective. For example, a spherical image could be an image of a globe. An inside perspective could be a view from a center of the globe looking outward. Or the inside perspective could be on the globe looking out to space. An outside perspective could be a view from space looking down toward the globe. As another example, perspective can be based on that which is viewable. In other words, a viewable perspective can be that which can be seen by a viewer. The viewable perspective can be a portion of the spherical image that is in front of the viewer. For example, when viewing from an inside perspective, a viewer could be lying on the ground (e.g., earth) and looking out to space. The viewer may see, in the image, the moon, the sun or specific stars. However, although the ground the viewer is lying on is included in the spherical image, the ground is outside the current viewable perspective. In this example, the viewer could turn her head and the ground would be included in a peripheral viewable perspective. The viewer could flip over and the ground would be in the viewable perspective whereas the moon, the sun or stars would not.

A viewable perspective from an outside perspective may be a portion of the spherical image that is not blocked (e.g., by another portion of the image) and/or a portion of the spherical image that has not curved out of view. Another portion of the spherical image may be brought into a viewable perspective from an outside perspective by moving (e.g., rotating) the spherical image and/or by movement of the spherical image. Therefore, the viewable perspective is a portion of the spherical image that is within a viewable range of a viewer of the spherical image.

A spherical image is an image that does not change with respect to time. For example, a spherical image from an inside perspective as relates to the earth may show the moon and the stars in one position. Whereas a spherical video (or sequence of images) may change with respect to time. For example, a spherical video from an inside perspective as relates to the earth may show the moon and the stars moving (e.g., because of the earths rotation) and/or an airplane streak across the image (e.g., the sky).

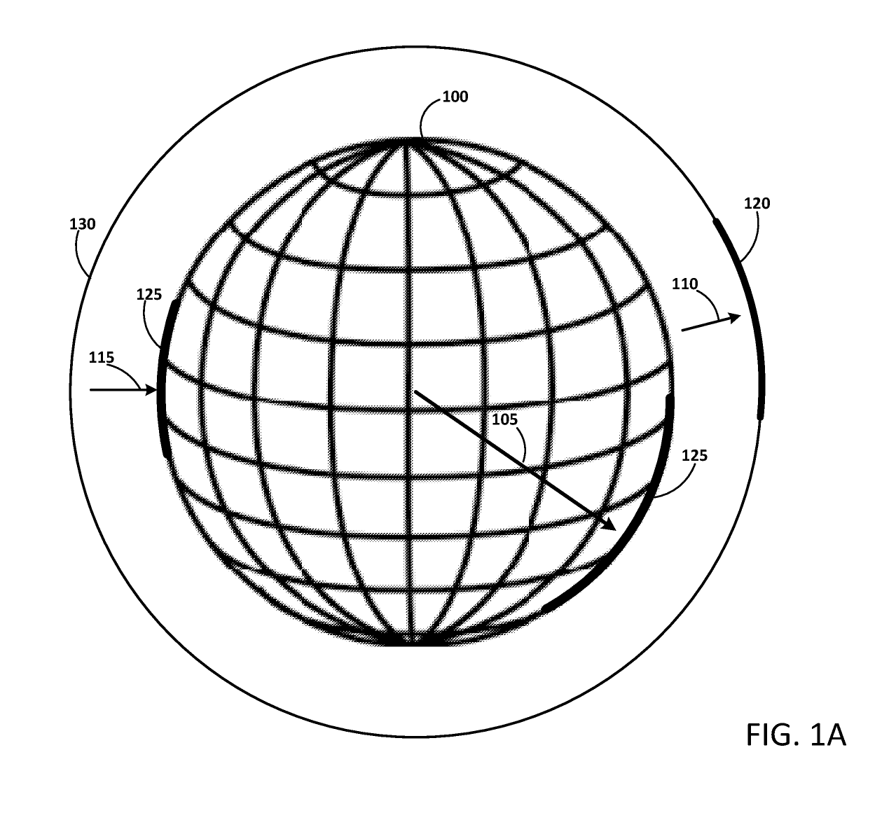

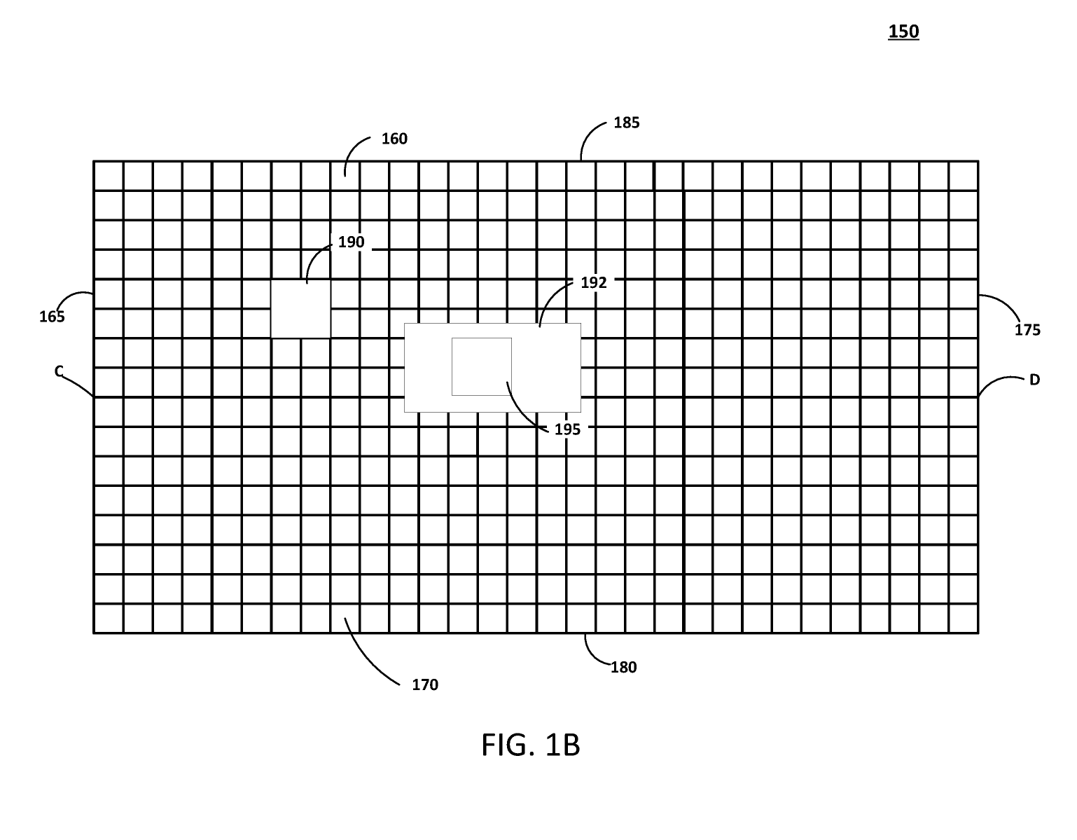

FIG. 1A is a two dimensional (2D) representation of a sphere. As shown in FIG. 1A, the sphere 100 (e.g., as a spherical image or frame of a spherical video) illustrates a direction of inside perspective 105, 110, outside perspective 115 and viewable perspective 120, 125, 130. The viewable perspective 120 may be a portion of a spherical image as viewed from inside perspective 110. The viewable perspective 120 may be a portion of the sphere 100 as viewed from inside perspective 105. The viewable perspective 125 may be a portion of the sphere 100 as viewed from outside perspective 115.

FIG. 1B illustrates an unwrapped cylindrical representation 150 of the 2D representation of a sphere 100 as a 2D rectangular representation. An equirectangular projection of an image shown as an unwrapped cylindrical representation 150 may appear as a stretched image as the image progresses vertically (up and down as shown in FIG. 1B) away from a mid line between points A and B. The 2-D rectangular representation can be decomposed as a C×R matrix of N×N blocks. For example, as shown in FIG. 1B, the illustrated unwrapped cylindrical representation 150 is a 30×16 matrix of N×N blocks. However, other C×R dimensions are within the scope of this disclosure. The blocks may be 2×2, 2×4, 4×4, 4×8, 8×8, 8×16, 16×16, and the like blocks (or blocks of pixels).

A spherical image is an image that is continuous in all directions. Accordingly, if the spherical image were to be decomposed into a plurality of blocks, the plurality of blocks would be contiguous over the spherical image. In other words, there are no edges or boundaries as in a 2D image. In example implementations, an adjacent end block may be adjacent to a boundary of the 2D representation. In addition, an adjacent end block may be a contiguous block to a block on a boundary of the 2D representation. For example, the adjacent end block being associated with two or more boundaries of the two dimensional representation. In other words, because a spherical image is an image that is continuous in all directions, an adjacent end can be associated with a top boundary (e.g., of a column of blocks) and a bottom boundary in an image or frame and/or associated with a left boundary (e.g., of a row of blocks) and a right boundary in an image or frame.

For example, if an equirectangular projection is used, an adjacent end block may be the block on the other end of the column or row. For example, as shown in FIG. 1B block 160 and 170 may be respective adjacent end blocks (by column) to each other. Further, block 180 and 185 may be respective adjacent end blocks (by column) to each other. Still further, block 165 and 175 may be respective adjacent end blocks (by row) to each other. A view perspective 192 may include (and/or overlap) at least one block. Blocks may be encoded as a region of the image, a region of the frame, a portion or subset of the image or frame, a group of blocks and the like. Hereinafter this group of blocks may be referred as a tile or a group of tiles. For example, tiles 190 and 195 are illustrated as a group of four blocks in FIG. 1B. Tile 195 is illustrated as being within view perspective 192.

In the example embodiments, in addition to streaming a frame of encoded spherical video a view perspective as a tile (or a group of tiles) selected based on at least one point of reference frequently viewed by viewers (e.g., at least one historically viewed point of reference or view perspectives), can be encoded at, for example, a higher quality (e.g., higher resolution and/or less distortion) and streamed together with (or as a portion of) the encoded frame of a spherical video. Accordingly, during play back, the viewer can view the decoded tiles (at the higher quality) while the entire spherical video is being played back and the entire spherical video is also available should the view perspective of a viewer change to a view perspective frequently viewed by viewers. The viewer can also change a viewing position or switch to another view perspective. If the another view perspective is included in the at least one point of reference frequently viewed by viewers, the played back video can be of a higher quality (e.g., higher resolution) than some other view perspective (e.g., on that is not one of the at least one point of reference frequently viewed by viewers).

In a head mount display (HMD), a viewer experiences a visual virtual reality through the use of a left (e.g., left eye) display and a right (e.g., right eye) display that projects a perceived three-dimensional (3D) video or image. According to example embodiments, a spherical (e.g., 3D) video or image is stored on a server. The video or image can be encoded and streamed to the HMD from the server. The spherical video or image can be encoded as a left image and a right image which packaged (e.g., in a data packet) together with metadata about the left image and the right image. The left image and the right image are then decoded and displayed by the left (e.g., left eye) display and the right (e.g., right eye) display.

The system(s) and method(s) described herein are applicable to both the left image and the right image and are referred to throughout this disclosure as an image, frame, a portion of an image, a portion of a frame, a tile and/or the like depending on the use case. In other words, the encoded data that is communicated from a server (e.g., streaming server) to a user device (e.g., a HMD) and then decoded for display can be a left image and/or a right image associated with a 3D video or image.

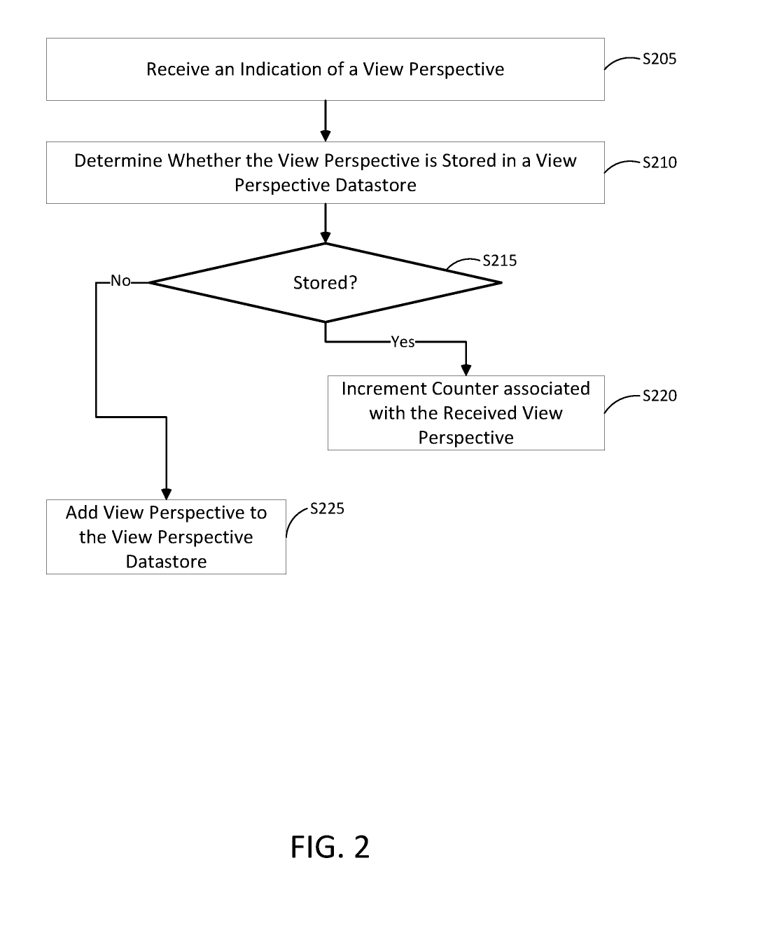

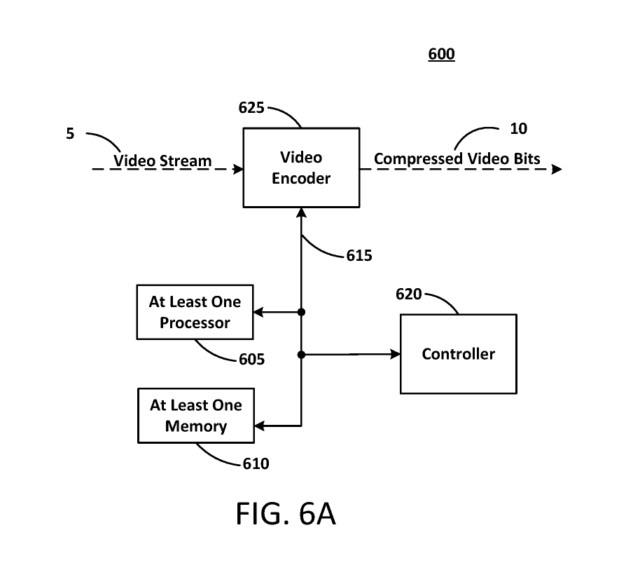

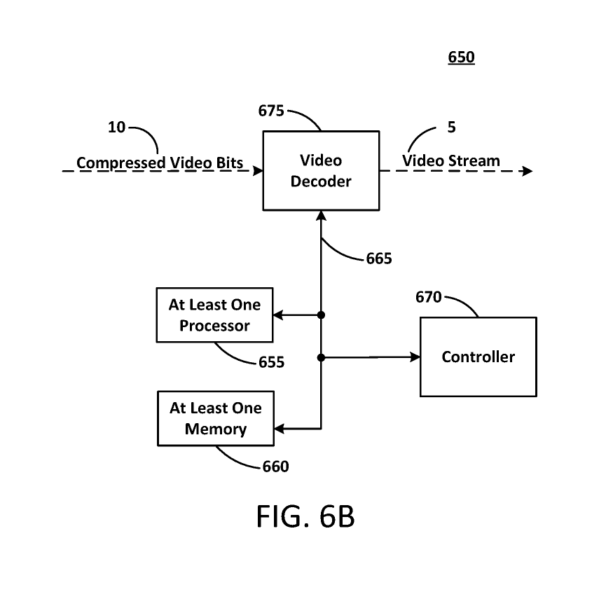

FIGS. 2-5 are flowcharts of methods according to example embodiments. The steps described with regard to FIGS. 2-5 may be performed due to the execution of software code stored in a memory (e.g., at least one memory 610) associated with an apparatus (e.g., as shown in FIGS. 6A, 6B, 7A, 7B and 8 (described below)) and executed by at least one processor (e.g., at least one processor 605) associated with the apparatus. However, alternative embodiments are contemplated such as a system embodied as a special purpose processor. Although the steps described below are described as being executed by a processor, the steps are not necessarily executed by a same processor. In other words, at least one processor may execute the steps described below with regard to FIGS. 2-5.

FIG. 2 illustrates a method for storing a historical view perspective. For example, FIG. 2 can illustrate the building of a database of commonly viewed view perspectives in a spherical video stream. As shown in FIG. 2, in step S205 an indication of a view perspective is received. For example, a tile can be requested by a device including a decoder. The tile request can include information based on a perspective or view perspective related to an orientation, a position, point or focal point of a viewer on a spherical video. The perspective or view perspective can be a user view perspective or a view perspective of a user of a HMD. For example, the view perspective (e.g., user view perspective) could be a latitude and longitude position on the spherical video (e.g., as an inside perspective or outside perspective). The view, perspective or view perspective can be determined as a side of a cube based on the spherical video. The indication of a view perspective can also include spherical video information. In an example implementation, the indication of a view perspective can include information about a frame (e.g., frame sequence) associated with the view perspective. For example, the view (e.g., latitude and longitude position or side) can be communicated from (a controller associated with) a user device including a HMD to a streaming server using, for example, a Hypertext Transfer Protocol (HTTP).

In step S210 whether the view perspective (e.g., user view perspective) is stored in a view perspective datastore is determined. For example, a datastore (e.g., view perspective datastore 815) can be queried or filtered based on the information associated with the view perspective or user view perspective. For example, the datastore could be queried or filtered based on the latitude and longitude position on the spherical video of the view perspective as well as a timestamp in the spherical video at which the view perspective was viewed. The timestamp can be a time and/or a range of times associated with playback of the spherical video. The query or filter can be based on a proximity in space (e.g., how close to a given stored view perspective the current view perspective is) and/or a proximity in time (e.g., how close to a given stored timestamp the current timestamp is). If the query or filter returns results, the view perspective is stored in the datastore. Otherwise, the view perspective is not stored in the datastore. If the view perspective is stored in the view perspective datastore, in step S215 processing continues to step S220. Otherwise, processing continues at step S225.

In step S220 a counter or ranking (or ranking value) associated with the received view perspective is incremented. For example, the datastore may include a datatable (e.g., a datastore may be a database including a plurality of datatables) including historical view perspectives. The datatable may be keyed (e.g., unique for each) view perspective. The datatable may include an identification of the view perspective, the information associated with the view perspective and a counter indicating how many times the view perspective has been requested. The counter may be incremented each time the view perspective is requested. The data stored in the datatable may be anonymized. In other words, the data can be stored such that there is no reference to (or identification of) a user, a device, a session and/or the like. As such, the data stored in the datatable is indistinguishable based on users or viewers of the video. In an example implementation, the data stored in the datatable may be categorized based on the user without identifying the user. For example, the data could include an age, age range, sex, type or role (e.g., musician or crowd) of the user and/or the like.

In step S225 the view perspective is added to the view perspective datastore. For example, an identification of the view perspective, the information associated with the view perspective and a counter (or ranking value) set to one (1) could be stored in the datatable including historical view perspectives.

In an example embodiment, tiles associated with at least one preferred view perspective can be encoded with a higher QoS. For example, an encoder (e.g., video encoder 625) can encode tiles associated with a 3D video individually. The tiles that associated with the at least one preferred view perspective can be encoded with the higher QoS than tiles associated with the remainder of the 3D video. In an example implementation, the 3D video can be encoded using first QoS parameter(s) (e.g., in a first pass) or at least one first QoS parameter used in a first encoding pass. In addition, the tiles associated with the at least one preferred view perspective can be encoded can be encoded using second QoS parameter(s) (e.g., in a second pass) or at least one second QoS parameter used in a second encoding pass. In this example implementation, the second QoS is a higher QoS than the first QoS. In another example implementation, the 3D video can be encoded as a plurality of tiles representing the 3D video. The tiles associated with the at least one preferred view perspective can be encoded using the second QoS parameter(s). The remaining tiles can be encoded using the first QoS parameter(s).

In an alternative implementation (and/or an additional implementation), the encoder can project a tile associated with the at least one preferred view perspective using a different projection technique or algorithm than that used to generate the 2D representation of the remainder of a 3D video frame. Some projections can have distortions in certain areas of the frame. Accordingly, projecting the tile differently than the spherical frame can improve the quality of the final image, and/or use pixels more efficiently. In one example implementation, the spherical image can be rotated before projecting the tile in order to orient the tile in a position that is minimally distorted based on the projection algorithm. In another example implementation, the tile can use (and/or modify) a projection algorithm that is based on the position of the tile. For example, projecting the spherical video frame to the 2D representation of can use an equirectangular projection, whereas projecting the spherical video frame to a representation including a portion to be selected as the tile can use a cubic projection.

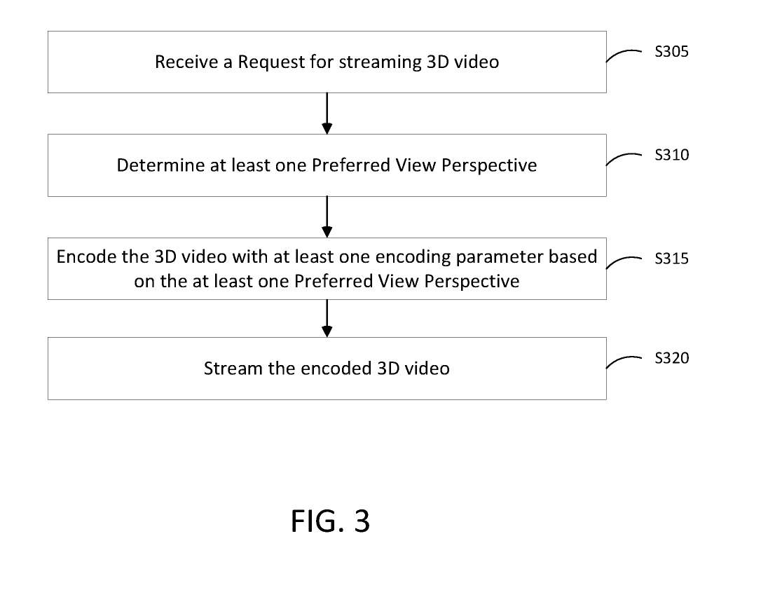

FIG. 3 illustrates a method for streaming 3D video. FIG. 3 describes a scenario where a streaming 3D video is encoded on demand, during a live streaming event and the like. As shown in FIG. 3, in step S305 a request for streaming 3D video is received. For example, a 3D video available to stream, a portion of a 3D video or a tile can be requested by a device including a decoder (e.g., via user interaction with a media application). The request can include information based on a perspective or view perspective related to an orientation, a position, point or focal point of a viewer on a spherical video. The information based on a perspective or view perspective can be based on a current orientation or a default (e.g., initialization) orientation. A default orientation can be, for example, a directors cut for the 3D video.

In step S310 at least one preferred view perspective is determined. For example, a datastore (e.g., view perspective datastore 815) can be queried or filtered based on the information associated with the view perspective. The datastore could be queried or filtered based on the latitude and longitude position on the spherical video of the view perspective. In an example implementation the at least one preferred view perspective can be based on historical view perspectives. As such, the datastore can include a datatable including historical view perspectives. Preference can be indicated by how many times a view perspective has been requested. Accordingly, the query or filter can include filtering out results below a threshold counter value. In other words, parameters set for a query of the datatable including the historical view perspectives can include a value for a counter or ranking where the results of the query should be above a threshold value for the counter. The results of the query of the datatable including the historical view perspectives can be set as the at least one preferred view perspective.

In addition, a default preferred view perspective (or view perspectives) can be associated with a 3D video. The default preferred view perspective can be a directors cut, points of interest (e.g., horizon, a moving object, a priority object) and/or the like. For example, the object of a game may be to destroy an object (e.g., a building or a vehicle). This object may be labeled as a priority object. A view perspective including the priority object can be indicated as a preferred view perspective. The default preferred view perspective can be included in addition to the historical view perspective or an alternative to the historical view perspective. A default orientation can be, for example, an initial set of preferred view perspective (e.g., for lack of historical data when a video is first uploaded) based on, for example an automated computer vision algorithm. The vision algorithm could determine a preferred view perspective portions of the video having motion or intricate detail, or nearby objects in stereo to infer what might be interesting and/or, features that were present in the preferred views of other historical videos.

Other factors can be used in determining the at least one preferred view perspective. For example, the at least one preferred view perspective can be historical view perspectives that are within a range of (e.g., proximate to) a current view perspective. For example, the at least one preferred view perspective can be historical view perspectives that are within a range of (e.g., proximate to) a historical view perspectives of a current user or group (type or category) the current user belongs to. In other words, the at least one preferred view perspective can include view perspectives (or tiles) that are close in distance and/or close in time to stored historical view perspectives. The default preferred view perspective(s) can be stored in the datastore 815 including the historical view perspectives or in a separate (e.g., additional) datastore not shown.

In step S315 the 3D video is encoded with at least one encoding parameter based on the at least one preferred view perspective. For example, the 3D video (or a portion thereof) can be encoded such that portions including the at least one preferred view perspective are encoded differently that the remainder of the 3D video. As such, portions including the at least one preferred view perspective can be encoded with a higher QoS than the remainder of the 3D video. As a result, when rendered on a HMD, the portions including the at least one preferred view perspective can have a higher resolution than the remainder of the 3D video.

In step S320 the encoded 3D video is streamed. For example, tiles may be included in a packet for transmission. The packet may include compressed video bits 10A. The packet may include the encoded 2D representation of the spherical video frame and the encoded tile (or plurality of tiles). The packet may include a header for transmission. The header may include, amongst other things, the information indicating the mode or scheme use in intra-frame coding by the encoder. The header may include information indicating parameters used to convert a frame of the spherical video frame to a 2D rectangular representation. The header may include information indicating parameters used to achieve the QoS of the encoded 2D rectangular representation and of the encoded tile. As discussed above, the QoS of the tiles associated with the at least one preferred view perspective can be different (e.g., higher) than the tiles not associated with the at least one preferred view perspective.

Streaming the 3D video can be implemented through the use of priority stages. For example, in a first priority stage a low (or minimum standard) QoS encoded video data can be streamed. This can allow a user of the HMD to begin the virtual reality experience. Subsequently, higher QoS video can be streamed to the HMD and replace (e.g., the data stored in buffer 830) previous streamed low (or minimum standard) QoS encoded video data. As an example, in a second stage, higher quality video or image data can be streamed based on the current view perspective. In a subsequent stage, higher QoS video or image data can be streamed based on the one or more preferred view perspective. This can continue, until the HMD buffer includes substantially only high QoS video or image data. In addition, this staged streaming can loop with progressively higher QoS video or image data. In other words, after a first iteration the HMD includes video or image data encoded at a first QoS, after a second iteration the HMD includes video or image data encoded at a second QoS, after a third iteration the HMD includes video or image data encoded at a third QoS, and so forth. In an example implementation, the second QoS is higher than the first QoS, the third QoS is higher than the second QoS and so forth.

Encoder 625 may operate off-line as part of a set-up procedure for making a spherical video available for streaming. Each of the plurality of tiles may be stored in view frame storage 795. Each of the plurality of tiles may be indexed such that each of the plurality of tiles can be stored with a reference to the frame (e.g., a time dependence) and a view (e.g., a view dependence). Accordingly, each of the plurality of tiles so that they are time and view, perspective or view perspective dependent and can be recalled based on the time and view dependence.

As such, in an example implementation, the encoder 625 may be configured to execute a loop where a frame is selected and a portion of the frame is selected as a tile based on a view perspective. The tile is then encoded and stored. The loop continues to cycle through a plurality of view perspectives. When a desired number of view perspective, for example, every 5 degrees around the vertical and every 5 degrees around the horizontal of the spherical image, are saved as tiles, a new frame is selected and the process repeats until all frames of the spherical video have a desired number of tiles saved for them. In an example embodiment, tiles associated with the at least one preferred view perspective can be encoded with a higher QoS than those tiles that are not tiles associated with the at least one preferred view perspective. This is but one example implementation for encoding and saving tiles. Other implementations are contemplated and within the scope of this disclosure.

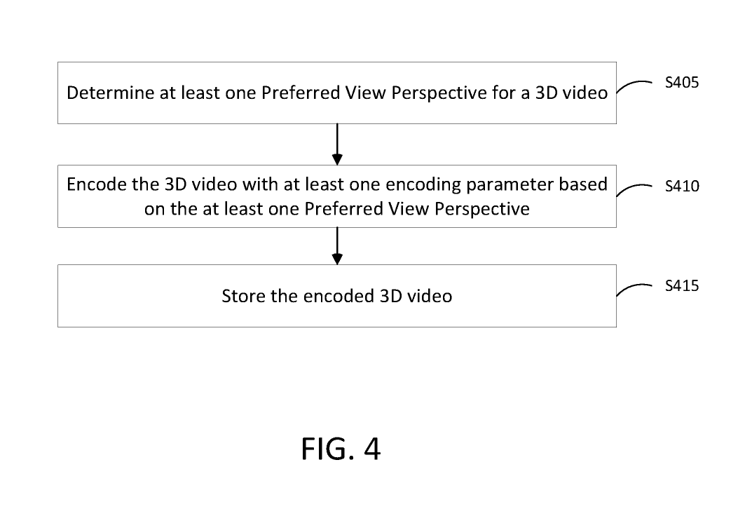

FIG. 4 illustrates a method for storing encoded 3D video. FIG. 4 describes a scenario where a streaming 3D video is previously encoded and stored for future streaming. As shown in FIG. 4, in step S405 at least one preferred view perspective for a 3D video is determined. For example, a datastore (e.g., view perspective datastore 815) can be queried or filtered based on the information associated with the view perspective. The datastore could be queried or filtered based on the latitude and longitude position on the spherical video of the view perspective. In an example implementation the at least one preferred view perspective can be based on historical view perspectives. As such, the datatable including historical view perspectives. Preference can be indicated by how many times a view perspective has been requested. Accordingly, the query or filter can include filtering out results below a threshold counter value. In other words, parameters set for a query of the datatable including the historical view perspectives can include a value for the counter where the results of the query should be above a threshold value for the counter. The results of the query of the datatable including the historical view perspectives can be set as the at least one preferred view perspective.

In addition, a default preferred view perspective (or view perspectives) can be associated with a 3D video. The default preferred view perspective can be a directors cut, points of interest (e.g., horizon, a moving object, a priority object) and/or the like. For example, the object of a game may be to destroy an object (e.g., a building or a vehicle). This object may be labeled as a priority object. A view perspective including the priority object can be indicated as a preferred view perspective. The default preferred view perspective can be included in addition to the historical view perspective or an alternative to the historical view perspective. Other factors can be used in determining the at least one preferred view perspective. For example, the at least one preferred view perspective can be historical view perspectives that are within a range (e.g., proximate to) a current view perspective. For example, the at least one preferred view perspective can be historical view perspectives that are within a range (e.g., proximate to) a historical view perspectives of a current user or group (type or category) the current user belongs to. The default preferred view perspective(s) can be stored in the datatable including the historical view perspectives or in a separate (e.g., additional) datatable.

In step S410 the 3D video is encoded with at least one encoding parameter based on the at least one preferred view perspective. For example, a frame of the 3D video can be selected and a portion of the frame can be selected as a tile based on a view perspective. The tile is then encoded. In an example embodiment, tiles associated with the at least one preferred view perspective can be encoded with the higher QoS. The tiles that are associated with the at least one preferred view perspective can be encoded with the higher QoS than tiles associated with the remainder of the 3D video.

In an alternative implementation (and/or an additional implementation), the encoder can project a tile associated with the at least one preferred view perspective using a different projection technique or algorithm than that used to generate the 2D representation of the remainder of a 3D video frame. Some projections can have distortions in certain areas of the frame. Accordingly, projecting the tile differently than the spherical frame can improve the quality of the final image, and/or use pixels more efficiently. In one example implementation, the spherical image can be rotated before projecting the tile in order to orient the tile in a position that is minimally distorted based on the projection algorithm. In another example implementation, the tile can use (and/or modify) a projection algorithm that is based on the position of the tile. For example, projecting the spherical video frame to the 2D representation of can use an equirectangular projection, whereas projecting the spherical video frame to a representation including a portion to be selected as the tile can use a cubic projection.

In step S415 the encoded 3D video is stored. For example, each of the plurality of tiles may be stored in view frame storage 795. Each of the plurality of tiles associated with the 3D video may be indexed such that each of the plurality of tiles are stored with a reference to the frame (e.g., a time dependence) and a view (e.g., a view dependence). Accordingly, each of the plurality of tiles so that they are time and view, perspective or view perspective dependent and can be recalled based on the time and view dependence.

In example implementations, the 3D video (e.g., the tiles associated therewith) may be encoded and stored with varying encoding parameters. Accordingly, the 3D video may be stored in different encoded states. The states may vary based on the QoS. For example, the 3D video may be stored as a plurality of tiles each encoded with the same QoS. For example, the 3D video may be stored as a plurality of tiles each encoded with a different QoS. For example, the 3D video may be stored as a plurality of tiles some encoded with a QoS based on the at least one preferred view perspective encoded.

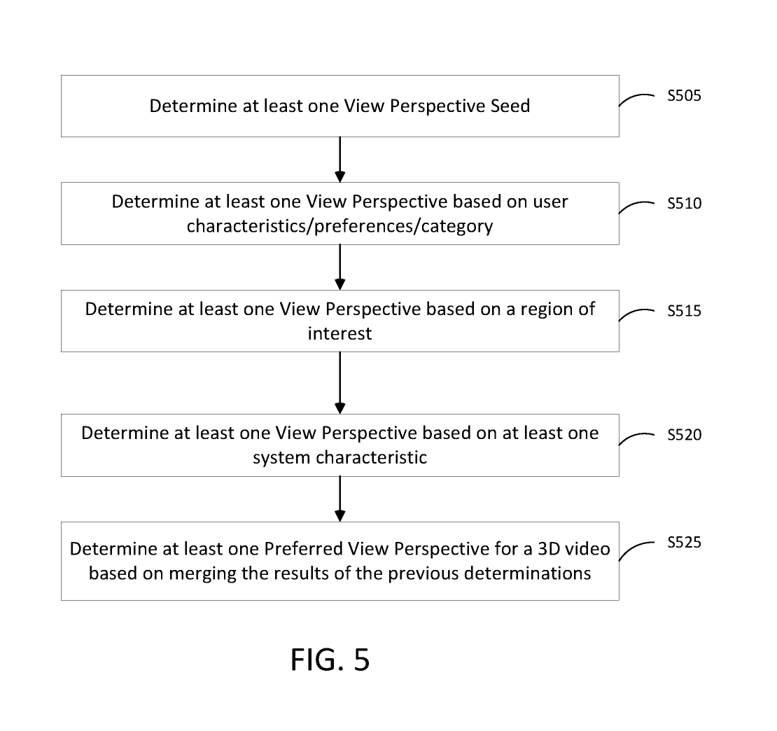

FIG. 5 illustrates a method for determining a preferred view perspective for a 3D video. The preferred view perspective for a 3D video may be in addition to a preferred view perspective based on historical viewing of the 3D video. As shown in FIG. 6, in step S505 at least one default view perspective is determined. For example, the default preferred view perspective(s) can be stored a datatable included in a datastore (e.g., view perspective datastore 815). The datastore can be queried or filtered based on a default indication for the 3D video. If the query or filter returns results, the 3D video has an associated default view perspective(s). Otherwise, the 3D video does not have an associated default view perspective. The default preferred view perspective can be a directors cut, points of interest (e.g., horizon, a moving object, a priority object) and/or the like. For example, the object of a game may be to destroy an object (e.g., a building or a vehicle). This object may be labeled as a priority object. A view perspective including the priority object can be indicated as a preferred view perspective.

In step S510 at least one view perspective based on user characteristics/preferences/category is determined. For example, a user of a HMD may have characteristics based on previous uses of the HMD. The characteristics may be based on statistical viewing preferences (e.g., a preference to look at close by objects as opposed to objects in the distance. For example, a user of the HMD may have stored user preferences associated with the HMD. The preferences may be chosen by a user as part of a set-up process. A preference may be general (e.g., attracted to movement) or video specific (e.g., prefer to focus on the guitarist for a music performance). For example, a user of the HMD may belong to a group or category (e.g., male between the ages of 15 and 22). For example, the user characteristics/preferences/category can be stored a datatable included in a datastore (e.g., view perspective datastore 815). The datastore can be queried or filtered based on a default indication for the 3D video. If the query or filter returns results, the 3D video has at least one associated preferred view perspective(s) based on an associated characteristics/preferences/category for the user. Otherwise, the 3D video does not have an associated view perspective based on the user.

In step S515 at least one view perspective based on a region of interest is determined. For example, the region of interest may be a current view perspective. For example, the at least one preferred view perspective can be historical view perspectives that are within a range (e.g., proximate to) a current view perspective. For example, the at least one preferred view perspective can be historical view perspectives that are within a range (e.g., proximate to) a historical view perspectives of a current user or group (type or category) the current user belongs to.

In step S520 at least one view perspective based on at least one system characteristic is determined. For example, a HMD may have features that may enhance a user experience. One feature may be enhanced audio. Therefore, in a virtual reality environment a user may be drawn to specific sounds (e.g., a game user may be drawn to explosions). The preferred view perspective may be based on view perspectives that include these audible cues. In step S525 at least one preferred view perspective for a 3D video based on each of the aforementioned view perspective determinations and/or combination/sub-combinations thereof. For example, at least one preferred view perspective may be generated by merging or joining the results of the aforementioned queries.

In the example of FIG. 6A, a video encoder system 600 may be, or include, at least one computing device and can represent virtually any computing device configured to perform the methods described herein. As such, the video encoder system 600 can include various components which may be utilized to implement the techniques described herein, or different or future versions thereof. By way of example, the video encoder system 600 is illustrated as including at least one processor 605, as well as at least one memory 610 (e.g., a non-transitory computer readable storage medium).

FIG. 6A illustrates the video encoder system according to at least one example embodiment. As shown in FIG. 6A, the video encoder system 600 includes the at least one processor 605, the at least one memory 610, a controller 620, and a video encoder 625. The at least one processor 605, the at least one memory 610, the controller 620, and the video encoder 625 are communicatively coupled via bus 615.

The at least one processor 605 may be utilized to execute instructions stored on the at least one memory 610, so as to thereby implement the various features and functions described herein, or additional or alternative features and functions. The at least one processor 605 and the at least one memory 610 may be utilized for various other purposes. In particular, the at least one memory 610 can represent an example of various types of memory and related hardware and software which might be used to implement any one of the modules described herein.

The at least one memory 610 may be configured to store data and/or information associated with the video encoder system 600. For example, the at least one memory 610 may be configured to store codecs associated with encoding spherical video. For example, the at least one memory may be configured to store code associated with selecting a portion of a frame of the spherical video as a tile to be encoded separately from the encoding of the spherical video. The at least one memory 610 may be a shared resource. As discussed in more detail below, the tile may be a plurality of pixels selected based on a view perspective of a viewer during playback of the spherical viewer (e.g., HMD). The plurality of pixels may be a block, plurality of blocks or macro-block that can include a portion of the spherical image that can be seen by the user. For example, the video encoder system 600 may be an element of a larger system (e.g., a server, a personal computer, a mobile device, and the like). Therefore, the at least one memory 610 may be configured to store data and/or information associated with other elements (e.g., image/video serving, web browsing or wired/wireless communication) within the larger system.

The controller 620 may be configured to generate various control signals and communicate the control signals to various blocks in video encoder system 600. The controller 620 may be configured to generate the control signals to implement the techniques described below. The controller 620 may be configured to control the video encoder 625 to encode an image, a sequence of images, a video frame, a video sequence, and the like according to example embodiments. For example, the controller 620 may generate control signals corresponding to parameters for encoding spherical video. More details related to the functions and operation of the video encoder 625 and controller 620 will be described below in connection with at least FIGS. 7A, 4A, 5A, 5B and 6-9.

The video encoder 625 may be configured to receive a video stream input 5 and output compressed (e.g., encoded) video bits 10. The video encoder 625 may convert the video stream input 5 into discrete video frames. The video stream input 5 may also be an image, accordingly, the compressed (e.g., encoded) video bits 10 may also be compressed image bits. The video encoder 625 may further convert each discrete video frame (or image) into a matrix of blocks (hereinafter referred to as blocks). For example, a video frame (or image) may be converted to a 16×16, a 16×8, an 8×8, an 8×4, a 4×4, a 4×2, a 2×2 or the like matrix of blocks each having a number of pixels. Although these example matrices are listed, example embodiments are not limited thereto.

The compressed video bits 10 may represent the output of the video encoder system 600. For example, the compressed video bits 10 may represent an encoded video frame (or an encoded image). For example, the compressed video bits 10 may be ready for transmission to a receiving device (not shown). For example, the video bits may be transmitted to a system transceiver (not shown) for transmission to the receiving device.

The at least one processor 605 may be configured to execute computer instructions associated with the controller 620 and/or the video encoder 625. The at least one processor 605 may be a shared resource. For example, the video encoder system 600 may be an element of a larger system (e.g., a mobile device). Therefore, the at least one processor 605 may be configured to execute computer instructions associated with other elements (e.g., image/video serving, web browsing or wired/wireless communication) within the larger system.

In the example of FIG. 6B, a video decoder system 650 may be at least one computing device and can represent virtually any computing device configured to perform the methods described herein. As such, the video decoder system 650 can include various components which may be utilized to implement the techniques described herein, or different or future versions thereof. By way of example, the video decoder system 650 is illustrated as including at least one processor 655, as well as at least one memory 660 (e.g., a computer readable storage medium).

Thus, the at least one processor 655 may be utilized to execute instructions stored on the at least one memory 660, so as to thereby implement the various features and functions described herein, or additional or alternative features and functions. The at least one processor 655 and the at least one memory 660 may be utilized for various other purposes. In particular, the at least one memory 660 can represent an example of various types of memory and related hardware and software which might be used to implement any one of the modules described herein. According to example embodiments, the video encoder system 600 and the video decoder system 650 may be included in a same larger system (e.g., a personal computer, a mobile device and the like). According to example embodiments, video decoder system 650 may be configured to implement the reverse or opposite techniques described with regard to the video encoder system 600.

The at least one memory 660 may be configured to store data and/or information associated with the video decoder system 650. For example, the at least one memory 610 may be configured to store codecs associated with decoding encoded spherical video data. For example, the at least one memory may be configured to store code associated with decoding an encoded tile and a separately encoded spherical video frame as well as code for replacing pixels in the decoded spherical video frame with the decoded tile. The at least one memory 660 may be a shared resource. For example, the video decoder system 650 may be an element of a larger system (e.g., a personal computer, a mobile device, and the like). Therefore, the at least one memory 660 may be configured to store data and/or information associated with other elements (e.g., web browsing or wireless communication) within the larger system.

The controller 670 may be configured to generate various control signals and communicate the control signals to various blocks in video decoder system 650. The controller 670 may be configured to generate the control signals in order to implement the video decoding techniques described below. The controller 670 may be configured to control the video decoder 675 to decode a video frame according to example embodiments. The controller 670 may be configured to generate control signals corresponding to decoding video. More details related to the functions and operation of the video decoder 675 and controller 670 will be described below.

The video decoder 675 may be configured to receive a compressed (e.g., encoded) video bits 10 input and output a video stream 5. The video decoder 675 may convert discrete video frames of the compressed video bits 10 into the video stream 5. The compressed (e.g., encoded) video bits 10 may also be compressed image bits, accordingly, the video stream 5 may also be an image.

The at least one processor 655 may be configured to execute computer instructions associated with the controller 670 and/or the video decoder 675. The at least one processor 655 may be a shared resource. For example, the video decoder system 650 may be an element of a larger system (e.g., a personal computer, a mobile device, and the like). Therefore, the at least one processor 655 may be configured to execute computer instructions associated with other elements (e.g., web browsing or wireless communication) within the larger system.

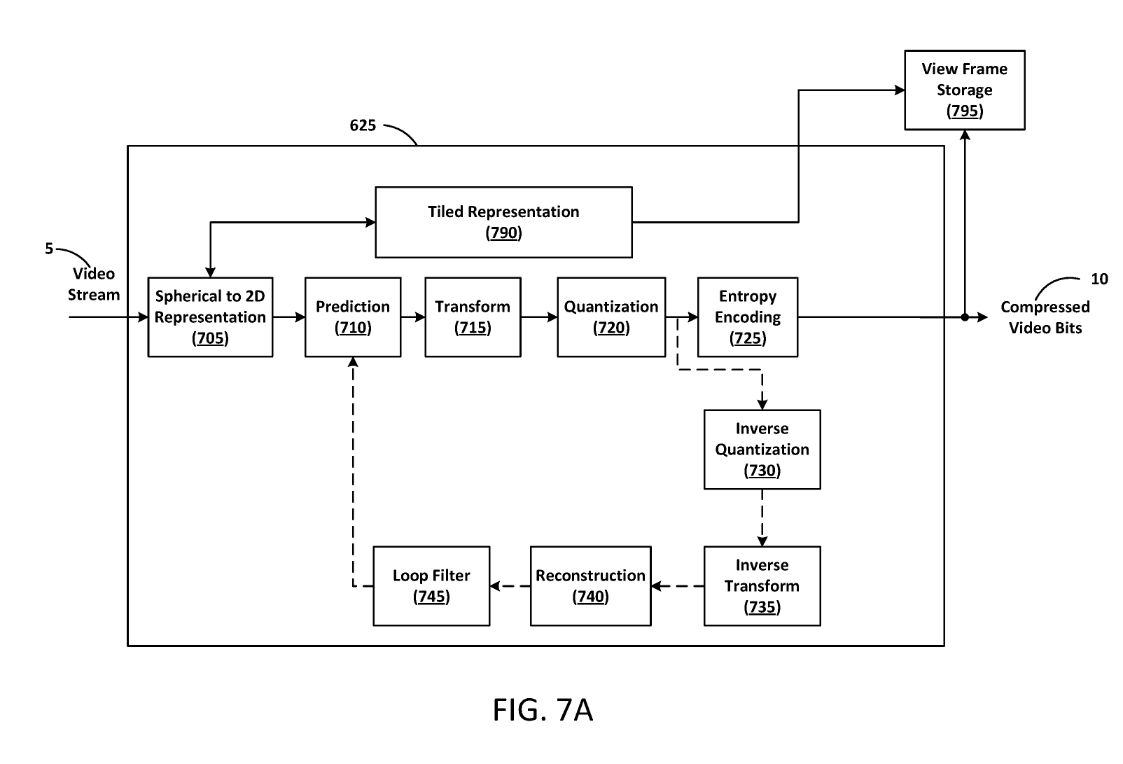

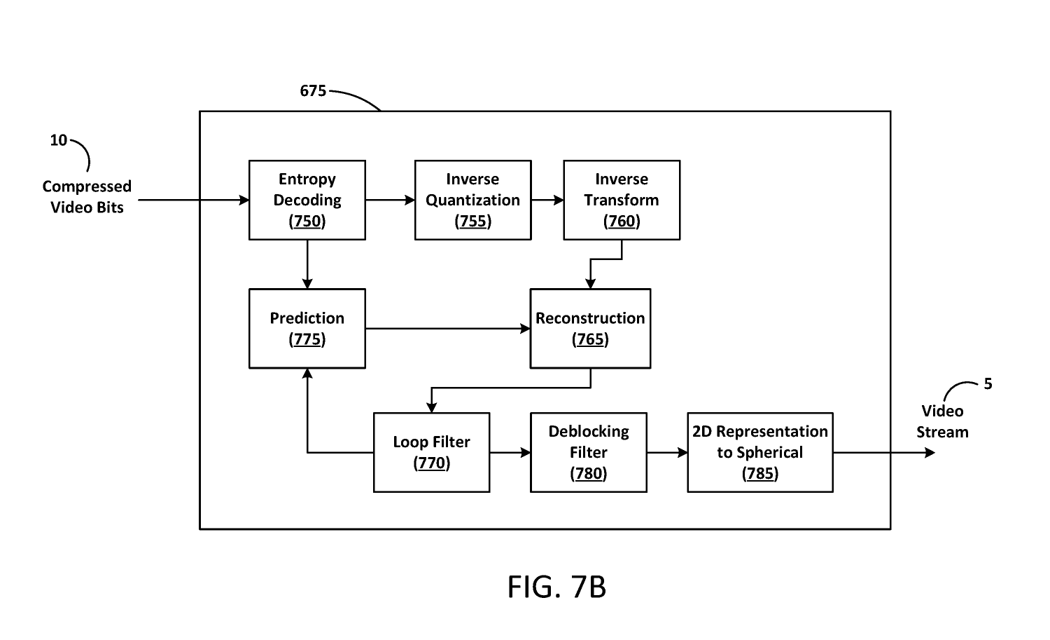

FIGS. 7A and 7B illustrate a flow diagram for the video encoder 625 shown in FIG. 6A and the video decoder 675 shown in FIG. 6B, respectively, according to at least one example embodiment. The video encoder 625 (described above) includes a spherical to 2D representation block 705, a prediction block 710, a transform block 715, a quantization block 720, an entropy encoding block 725, an inverse quantization block 730, an inverse transform block 735, a reconstruction block 740, a loop filter block 745, a tile representation block 790 and a view frame storage 795. Other structural variations of video encoder 625 can be used to encode input video stream 5. As shown in FIG. 7A, dashed lines represent a reconstruction path amongst the several blocks and solid lines represent a forward path amongst the several blocks.

Each of the aforementioned blocks may be executed as software code stored in a memory (e.g., at least one memory 610) associated with a video encoder system (e.g., as shown in FIG. 6A) and executed by at least one processor (e.g., at least one processor 605) associated with the video encoder system. However, alternative embodiments are contemplated such as a video encoder embodied as a special purpose processor. For example, each of the aforementioned blocks (alone and/or in combination) may be an application-specific integrated circuit, or ASIC. For example, the ASIC may be configured as the transform block 715 and/or the quantization block 720.

The spherical to 2D representation block 705 may be configured to map a spherical frame or image to a 2D representation of the spherical frame or image. For example, a sphere can be projected onto the surface of another shape (e.g., square, rectangle, cylinder and/or cube). The projection can be, for example, equirectangular or semi-equirectangular.

The prediction block 710 may be configured to utilize video frame coherence (e.g., pixels that have not changed as compared to previously encoded pixels). Prediction may include two types. For example, prediction may include intra-frame prediction and inter-frame prediction. Intra-frame prediction relates to predicting the pixel values in a block of a picture relative to reference samples in neighboring, previously coded blocks of the same picture. In intra-frame prediction, a sample is predicted from reconstructed pixels within the same frame for the purpose of reducing the residual error that is coded by the transform (e.g., entropy encoding block 725) and entropy coding (e.g., entropy encoding block 725) part of a predictive transform codec. Inter-frame prediction relates to predicting the pixel values in a block of a picture relative to data of a previously coded picture.

The transform block 715 may be configured to convert the values of the pixels from the spatial domain to transform coefficients in a transform domain. The transform coefficients may correspond to a two-dimensional matrix of coefficients that is ordinarily the same size as the original block. In other words, there may be as many transform coefficients as pixels in the original block. However, due to the transform, a portion of the transform coefficients may have values equal to zero.

The transform block 715 may be configured to transform the residual (from the prediction block 710) into transform coefficients in, for example, the frequency domain. Typically, transforms include the Karhunen-Loève Transform (KLT), the Discrete Cosine Transform (DCT), the Singular Value Decomposition Transform (SVD) and the asymmetric discrete sine transform (ADST).

The quantization block 720 may be configured to reduce the data in each transformation coefficient. Quantization may involve mapping values within a relatively large range to values in a relatively small range, thus reducing the amount of data needed to represent the quantized transform coefficients. The quantization block 720 may convert the transform coefficients into discrete quantum values, which are referred to as quantized transform coefficients or quantization levels. For example, the quantization block 720 may be configured to add zeros to the data associated with a transformation coefficient. For example, an encoding standard may define 128 quantization levels in a scalar quantization process.

The quantized transform coefficients are then entropy encoded by entropy encoding block 725. The entropy-encoded coefficients, together with the information required to decode the block, such as the type of prediction used, motion vectors and quantizer value, are then output as the compressed video bits 10. The compressed video bits 10 can be formatted using various techniques, such as run-length encoding (RLE) and zero-run coding.

The reconstruction path in FIG. 7A is present to ensure that both the video encoder 625 and the video decoder 675 (described below with regard to FIG. 7B) use the same reference frames to decode compressed video bits 10 (or compressed image bits). The reconstruction path performs functions that are similar to functions that take place during the decoding process that are discussed in more detail below, including inverse quantizing the quantized transform coefficients at the inverse quantization block 730 and inverse transforming the inverse quantized transform coefficients at the inverse transform block 735 in order to produce a derivative residual block (derivative residual). At the reconstruction block 740, the prediction block that was predicted at the prediction block 710 can be added to the derivative residual to create a reconstructed block. A loop filter 745 can then be applied to the reconstructed block to reduce distortion such as blocking artifacts.

The tile representation block 790 can be configured to convert an image and/or a frame into a plurality of tiles. A tile can be a grouping of pixels. The tile may be a plurality of pixels selected based on a view or view perspective. The plurality of pixels may be a block, plurality of blocks or macro-block that can include a portion of the spherical image that can be seen by the user (or predicted to be seen). The portion of the spherical image, as the tile) may have a length and width. The portion of the spherical image may be two dimensional or substantially two dimensional. The tile can have a variable size (e.g., how much of the sphere the tile covers). For example, the size of the tile can be encoded and streamed based on, for example, how wide the viewer's field of view is, proximity to another tile, and/or how quickly the user is rotating their head. For example, if the viewer is continually looking around, then larger, lower quality tiles may be selected. However, if the viewer is focusing on one perspective, smaller more detailed tiles may be selected.

In one implementation, the tile representation block 790 initiates an instruction to the spherical to 2D representation block 705 causing the spherical to 2D representation block 705 to generate tiles. In another implementation, the tile representation block 790 generates tiles. In either implementation, each tile is then individually encoded. In still another implementation the tile representation block 790 initiates an instruction to the view frame storage 795 causing the view frame storage 795 to store encoded images and/or video frames as tiles. The tile representation block 790 can initiate an instruction to the view frame storage 795 causing the view frame storage 795 to store the tile with information or metadata about the tile. For example, the information or metadata about the tile may include an indication of the tiles position within the image or frame, information associated with encoding the tile (e.g., resolution, bandwidth and/or a 3D to 2D projection algorithm), an association with one or more region of interest and/or the like.

According to an example implementation, the encoder 625 may encode a frame, a portion of a frame and/or a tile at a different quality (or quality of service (QoS)). According to example embodiments, the encoder 625 may encode a frame, a portion of a frame and/or a tile a plurality of times each at a different QoS. Accordingly, the view frame storage 795 can store a frame, a portion of a frame and/or a tile representing the same position within an image or frame at different QoS. As such, the aforementioned information or metadata about the tile may include an indication of a QoS at which the frame, the portion of the frame and/or the tile was encoded.

The QoS can be based on compression algorithm, a resolution, a transmission rate, and/or an encoding scheme. Therefore, the encoder 625 may use a different compression algorithm and/or encoding scheme for each frame, portion of a frame and/or tile. For example, an encoded tile may be at a higher QoS than the frame (associated with the tile) is encoded by the encoder 625. As discussed above, encoder 625 may be configured to encode a 2D representation of the spherical video frame. Accordingly, the tile (as a viewable perspective including a portion of the spherical video frame) can be encoded with a higher QoS than the 2D representation of the spherical video frame. The QoS may affect the resolution of the frame when decoded. Accordingly, the tile (as a viewable perspective including a portion of the spherical video frame) can be encoded such that the tile has a higher resolution of the frame when decoded as compared to a decoded 2D representation of the spherical video frame. The tile representation block 790 may indicate a QoS at which the tile should be encoded. The tile representation block 790 may select the QoS based on whether or not the frame, portion of the frame and/or the tile is a region of interest, within a region of interest, associated with a seed region and/or the like. A region of interest and a seed region are described in more detail below.

The video encoder 625 described above with regard to FIG. 7A includes the blocks shown. However, example embodiments are not limited thereto. Additional blocks may be added based on the different video encoding configurations and/or techniques used. Further, each of the blocks shown in the video encoder 625 described above with regard to FIG. 7A may be optional blocks based on the different video encoding configurations and/or techniques used.

FIG. 7B is a schematic block diagram of a decoder 675 configured to decode compressed video bits 10 (or compressed image bits). Decoder 675, similar to the reconstruction path of the encoder 625 discussed previously, includes an entropy decoding block 750, an inverse quantization block 755, an inverse transform block 760, a reconstruction block 765, a loop filter block 770, a prediction block 775, a deblocking filter block 780 and a 2D representation to spherical block 785.

The data elements within the compressed video bits 10 can be decoded by entropy decoding block 750 (using, for example, Context Adaptive Binary Arithmetic Decoding) to produce a set of quantized transform coefficients. Inverse quantization block 755 dequantizes the quantized transform coefficients, and inverse transform block 760 inverse transforms (using ADST) the dequantized transform coefficients to produce a derivative residual that can be identical to that created by the reconstruction stage in the encoder 625.

Using header information decoded from the compressed video bits 10, decoder 675 can use prediction block 775 to create the same prediction block as was created in encoder 675. The prediction block can be added to the derivative residual to create a reconstructed block by the reconstruction block 765. The loop filter block 770 can be applied to the reconstructed block to reduce blocking artifacts. Deblocking filter block 780 can be applied to the reconstructed block to reduce blocking distortion, and the result is output as video stream 5.

The 2D representation to spherical block 785 may be configured to map a 2D representation of a spherical frame or image to a spherical frame or image. For example, mapping of the 2D representation of a spherical frame or image to the spherical frame or image can be the inverse of the 3D-2D mapping performed by the encoder 625.

The video decoder 675 described above with regard to FIG. 7B includes the blocks shown. However, example embodiments are not limited thereto. Additional blocks may be added based on the different video encoding configurations and/or techniques used. Further, each of the blocks shown in the video decoder 675 described above with regard to FIG. 7B may be optional blocks based on the different video encoding configurations and/or techniques used.

The encoder 625 and the decoder 675 may be configured to encode spherical video and/or images and to decode spherical video and/or images, respectively. A spherical image is an image that includes a plurality of pixels spherically organized. In other words, a spherical image is an image that is continuous in all directions. Accordingly, a viewer of a spherical image can reposition or reorient (e.g., move her head or eyes) in any direction (e.g., up, down, left, right, or any combination thereof) and continuously see a portion of the image.

In an example implementation, parameters used in and/or determined by encoder 625 can be used by other elements of the encoder 405. For example, motion vectors (e.g., as used in prediction) used to encode the 2D representation could be used to encode the tile. Further, parameters used in and/or determined by the prediction block 710, the transform block 715, the quantization block 720, the entropy encoding block 725, the inverse quantization block 730, the inverse transform block 735, the reconstruction block 740, and the loop filter block 745 could be shared between encoder 625 and the encoder 405.

The portion of the spherical video frame or image may be processed as an image. Therefore, the portion of the spherical video frame may be converted (or decomposed) to a C×R matrix of blocks (hereinafter referred to as blocks). For example, the portion of the spherical video frame may be converted to a C×R matrix of 16×16, a 16×8, an 8×8, an 8×4, a 4×4, a 4×2, a 2×2 or the like matrix of blocks each having a number of pixels.

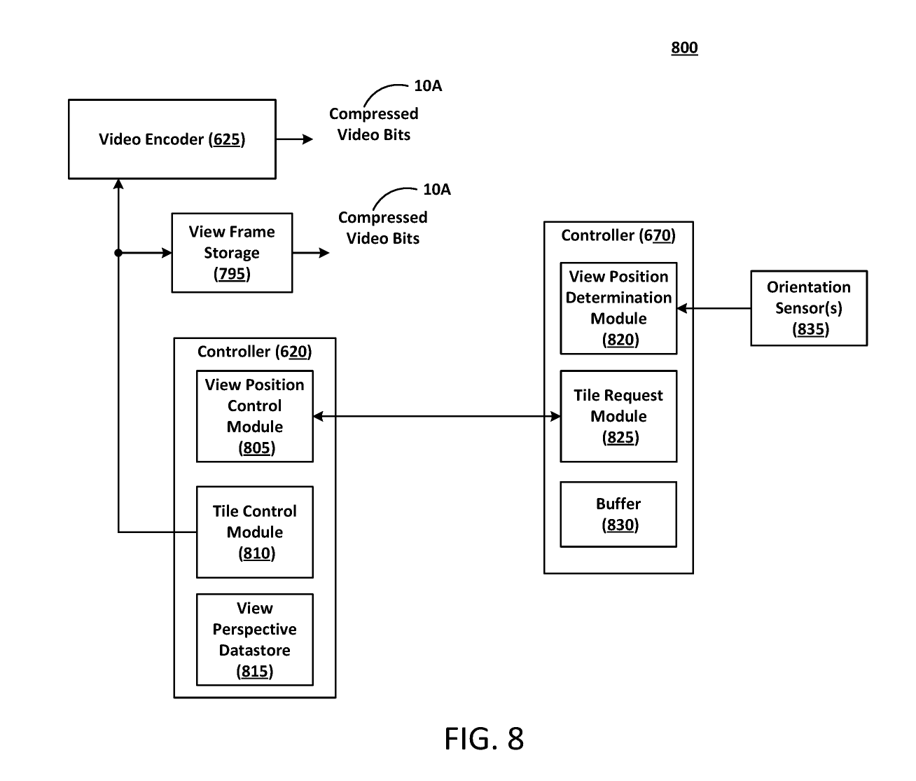

FIG. 8 illustrates a system 800 according to at least one example embodiment. As shown in FIG. 8, the system 700 includes the controller 620, the controller 670, the video encoder 625, the view frame storage 795 and an orientation sensor(s) 835. The controller 620 further includes a view position control module 805, a tile control module 810 and a view perspective datastore 815. The controller 670 further includes a view position determination module 820, a tile request module 825 and a buffer 830.

According to an example implementation, the orientation sensor 835 detects an orientation (or change in orientation) of a viewers eyes (or head), the view position determination module 820 determines a view, perspective or view perspective based on the detected orientation and the tile request module 825 communicates the view, perspective or view perspective as part of a request for a tile or a plurality of tiles (in addition to the spherical video). According to another example implementation, the orientation sensor 835 detects an orientation (or change in orientation) based on an image panning orientation as rendered on a HMD or a display. For example, a user of the HMD may change a depth of focus. In other words, the user of the HMD may change her focus to an object that is close from an object that was further away (or vice versa) with or without a change in orientation. For example, a user may use a mouse, a track pad or a gesture (e.g., on a touch sensitive display) to select, move, drag, expand and/or the like a portion of the spherical video or image as rendered on the display.

The request for the tile may be communicated together with a request for a frame of the spherical video. The request for the tile may be communicated together separate from a request for a frame of the spherical video. For example, the request for the tile may be in response to a changed view, perspective or view perspective resulting in a need to replace previously requested and/or queued tiles.

The view position control module 805 receives and processes the request for the tile. For example, the view position control module 805 can determine a frame and a position of the tile or plurality of tiles in the frame based on the view. Then the view position control module 805 can instruct the tile control module 810 to select the tile or plurality of tiles. Selecting the tile or plurality of tiles can include passing a parameter to the video encoder 625. The parameter can be used by the video encoder 625 during the encoding of the spherical video and/or tile. Alternatively, selecting the tile or plurality of tiles can include selecting the tile or plural of tiles from the view frame storage 795.

Accordingly, the tile control module 810 may be configured to select a tile (or plurality of tiles) based a view or perspective or view perspective of a user watching the spherical video. The tile may be a plurality of pixels selected based on the view. The plurality of pixels may be a block, plurality of blocks or macro-block that can include a portion of the spherical image that can be seen by the user. The portion of the spherical image may have a length and width. The portion of the spherical image may be two dimensional or substantially two dimensional. The tile can have a variable size (e.g., how much of the sphere the tile covers). For example, the size of the tile can be encoded and streamed based on, for example, how wide the viewer's field of view is and/or how quickly the user is rotating their head. For example, if the viewer is continually looking around, then larger, lower quality tiles may be selected. However, if the viewer is focusing on one perspective, smaller more detailed tiles may be selected.

Accordingly, the orientation sensor 835 can be configured to detect an orientation (or change in orientation) of a viewers eyes (or head). For example, the orientation sensor 835 can include an accelerometer in order to detect movement and a gyroscope in order to detect orientation. Alternatively, or in addition to, the orientation sensor 835 can include a camera or infra-red sensor focused on the eyes or head of the viewer in order to determine a orientation of the eyes or head of the viewer. Alternatively, or in addition to, the orientation sensor 835 can determine a portion of the spherical video or image as rendered on the display in order to detect an orientation of the spherical video or image. The orientation sensor 835 can be configured to communicate orientation and change in orientation information to the view position determination module 820.

The view position determination module 820 can be configured to determine a view or perspective view (e.g., a portion of a spherical video that a viewer is currently looking at) in relation to the spherical video. The view, perspective or view perspective can be determined as a position, point or focal point on the spherical video. For example, the view could be a latitude and longitude position on the spherical video. The view, perspective or view perspective can be determined as a side of a cube based on the spherical video. The view (e.g., latitude and longitude position or side) can be communicated to the view position control module 805 using, for example, a Hypertext Transfer Protocol (HTTP).

The view position control module 805 may be configured to determine a view position (e.g., frame and position within the frame) of a tile or plurality of tiles within the spherical video. For example, the view position control module 805 can select a rectangle centered on the view position, point or focal point (e.g., latitude and longitude position or side). The tile control module 810 can be configured to select the rectangle as a tile or plurality of tiles. The tile control module 810 can be configured to instruct (e.g., via a parameter or configuration setting) the video encoder 625 to encode the selected tile or plurality of tiles and/or the tile control module 810 can be configured to select the tile or plurality of tiles from the view frame storage 795.

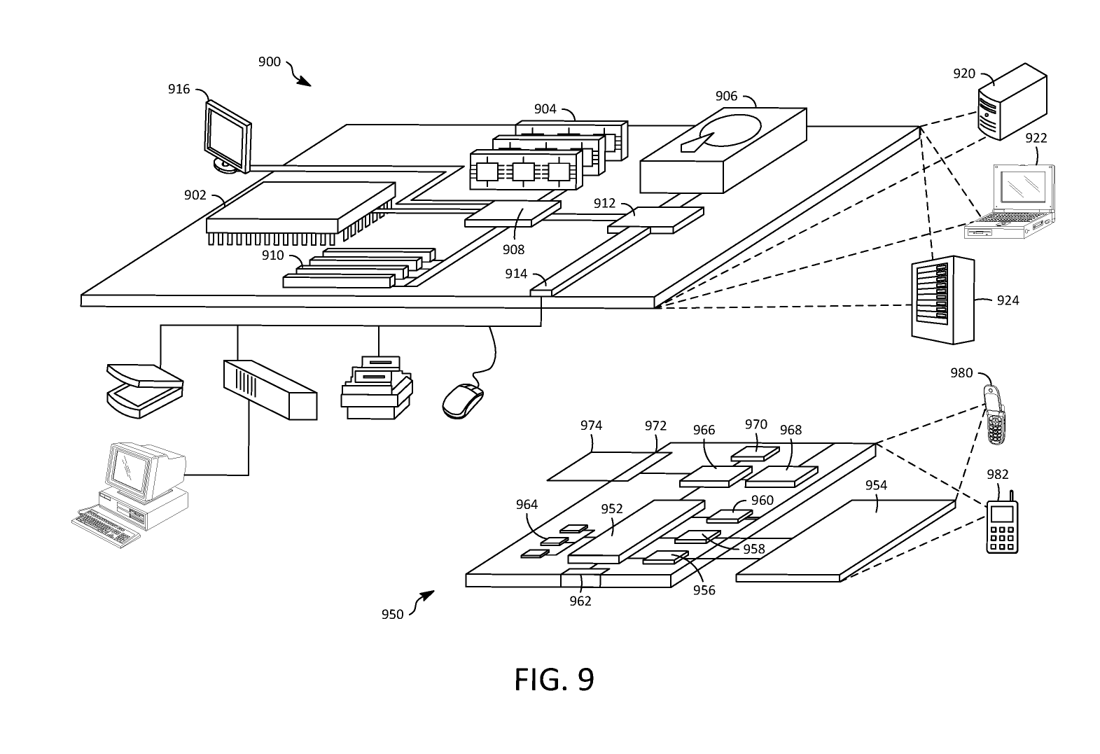

As will be appreciated, the system 600 and 650 illustrated in FIGS. 6A and 6B and/or system 800 illustrated in FIG. 8 may be implemented as an element of and/or an extension of the generic computer device 900 and/or the generic mobile computer device 950 described below with regard to FIG. 9. Alternatively, or in addition to, the system 600 and 650 illustrated in FIGS. 6A and 6B and/or system 800 illustrated in FIG. 8 may be implemented in a separate system from the generic computer device 900 and/or the generic mobile computer device 950 having some or all of the features described below with regard to the generic computer device 900 and/or the generic mobile computer device 950.

FIG. 9 is a schematic block diagram of a computer device and a mobile computer device that can be used to implement the techniques described herein. FIG. 9 is an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing partitions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method comprising:
determining at least one preferred view perspective associated with a three dimensional (3D) video;
encoding a first portion of the 3D video corresponding to the at least one preferred view perspective at a first quality; and
encoding a second portion of the 3D video at a second quality, the first quality being a higher quality as compared to the second quality.

2. The method of claim 1, further comprising:
storing the first portion of the 3D video in a datastore;
storing the second portion of the 3D video in the datastore;
receiving a request for a streaming video; and
streaming the first portion of the 3D video and the second portion of the 3D video from the datastore as the streaming video.

3. The method of claim 1, further comprising:
receiving a request for a streaming video, the request including an indication of a user view perspective;
selecting 3D video corresponding to the user view perspective as the encoded first portion of the 3D video; and
streaming the selected first portion of the 3D video and the second portion of the 3D video as the streaming video.

4. The method of claim 1, further comprising:
receiving a request for a streaming video, the request including an indication of a user view perspective associated with the 3D video;
determining whether the user view perspective is stored in a view perspective datastore;
upon determining the user view perspective is stored in the view perspective datastore, increment a counter associated with the user view perspective; and
upon determining the user view perspective is not stored in the view perspective datastore, add the user view perspective to the view perspective datastore and set the counter associated with the user view perspective to one (1).

5. The method of claim 1, wherein
encoding the second portion of the 3D video includes using at least one first Quality of Service QoS parameter in a first pass encoding operation, and
encoding the first portion of the 3D video includes using at least one second Quality of Service QoS parameter in a second pass encoding operation.

6. The method of claim 1, wherein the determining of the at least one preferred view perspective associated with the 3D video is based on at least one of a historically viewed point of reference and a historically viewed view perspective.

7. The method of claim 1, wherein the at least one preferred view perspective associated with the 3D video is based on at least one of an orientation of a viewer of the 3D video, a position of a viewer of the 3D video, point of a viewer of the 3D video and focal point of a viewer of the 3D video.

8. The method of claim 1, wherein
the determining of the at least one preferred view perspective associated with the 3D video is based on a default view perspective, and
the default view perspective based on at least one of:
a characteristic of a user of a display device,
a characteristic of a group associated with the user of the display device,
a directors cut, and
a characteristic of the 3D video.

9. The method of claim 1, further comprising:
iteratively encoding at least one portion of the second portion of the 3D video at the first quality; and
streaming the least one portion of the second portion of the 3D video.

10. A streaming server comprising:
a controller configured to determine at least one preferred view perspective associated with a three dimensional (3D) video; and
an encoder configured to:
encode a first portion of the 3D video corresponding to the at least one preferred view perspective at a first quality, and
encode a second portion of the 3D video at a second quality, the first quality being a higher quality as compared to the second quality.

11. The streaming server of claim 10, wherein the controller is further configured to cause the:
storing of the first portion of the 3D video in a datastore,
storing of the second portion of the 3D video in the datastore,
receiving of a request for a streaming video, and
streaming of the first portion of the 3D video and the second portion of the 3D video from the datastore as the streaming video.

12. The streaming server of claim 10, wherein the controller is further configured to cause the:
receiving of a request for a streaming video, the request including an indication of a user view perspective,
selecting of 3D video corresponding to the user view perspective as the encoded first portion of 3D video, and
streaming of the selected first portion of the 3D video and the second portion of the 3D video as the streaming video.

13. The streaming server of claim 10, wherein the controller is further configured to cause the:
receiving of a request for a streaming video, the request including an indication of a user view perspective associated with the 3D video,
determining of whether the user view perspective is stored in a view perspective datastore,
upon determining the user view perspective is stored in the view perspective datastore, increment a counter associated with the user view perspective, and
upon determining the user view perspective is not stored in the view perspective datastore, add the user view perspective to the view perspective datastore and set the counter associated with the user view perspective to one (1).

14. The streaming server of claim 10, wherein
encoding the second portion of the 3D video includes using at least one first Quality of Service QoS parameter in a first pass encoding operation, and
encoding the first portion of the 3D video includes using at least one second Quality of Service QoS parameter in a second pass encoding operation.

15. The streaming server of claim 10, wherein the determining of the at least one preferred view perspective associated with the 3D video is based on at least one of a historically viewed point of reference and a historically viewed view perspective.

16. The streaming server of claim 10, wherein the at least one preferred view perspective associated with the 3D video is based on at least one of an orientation of a viewer of the 3D video, a position of a viewer of the 3D video, point of a viewer of the 3D video and focal point of a viewer of the 3D video.

17. The streaming server of claim 10, wherein
the determining of the at least one preferred view perspective associated with the 3D video is based on a default view perspective, and
the default view perspective based on at least one of:
a characteristic of a user of a display device,
a characteristic of a group associated with the user of the display device,
a directors cut, and
a characteristic of the 3D video.

18. The streaming server of claim 10, wherein the controller is further configured to cause the:
iteratively encoding of at least one portion of the second portion of the 3D video at the first quality, and
streaming of the least one portion of the second portion of the 3D video.

19. A method comprising:
receiving a request for a streaming video, the request including an indication of a user view perspective associated with a three dimensional (3D) video;
determining whether the user view perspective is stored in a view perspective datastore;
upon determining the user view perspective is stored in the view perspective datastore, increment a ranking value associated with the user view perspective; and
upon determining the user view perspective is not stored in the view perspective datastore, add the user view perspective to the view perspective datastore and set the ranking value associated with the user view perspective to one (1).

20. The method of claim 19, further comprising:
determining at least one preferred view perspective associated with the 3D video based on the ranking value associated with the stored user view perspective and a threshold value;
encoding a first portion of the 3D video corresponding to the at least one preferred view perspective at a first quality; and
encoding a second portion of the 3D video at a second quality, the first quality being a higher quality as compared to the second quality.
